(19) United States
(12) Patent Application Publication
(10) Pub. No.: US 2026/0031104 A1
(43) Pub. Date: Jan. 29, 2026

(54) METHOD OF MANUFACTURING MAGNETIC RECORDING MEDIUM

(71) Applicant: Resonac Hard Disk Corporation, Chiba (JP)

(72) Inventors: Ayumi YAMAKAWA, Chiba (JP); Kazunori OHASHI, Chiba (JP); Koshiro YOSHIYAMA, Chiba (JP); Kazuhiro MAKISHIMA, Tokyo (JP); Shota SHIMADA, Tokyo (JP)

(21) Appl. No.: 19/276,480

(22) Filed: Jul. 22, 2025

(30) Foreign Application Priority Data
Jul. 26, 2024 (JP) 2024-121359

(51) Int. Cl. G11B 5/708; G11B 5/627

(52) U.S. Cl. CPC G11B 5/7085; G11B 5/627

(57) ABSTRACT

A method of manufacturing a magnetic recording medium includes burnishing, with an abrasive material, a surface of a stack including a magnetic recording layer and a protective layer stacked on a substrate in order of the magnetic recording layer and the protective layer. The burnishing of the surface of the stack includes using a long abrasive tape including abrasive grains as the abrasive material fixed onto a support in a state of being wound in roll form, and pressing the abrasive tape, supplied from the state of being wound in the roll form, against the surface of the stack so as to rub the surface of the stack. The abrasive tape in the state of being wound in the roll form is subjected to vacuum treatment in advance such that loose abrasive grains are reduced.

### CROSS-REFERENCE TO RELATED APPLICATIONS

This application is based on and claims priority to Japanese Patent Application No. 2024-121359, filed on Jul. 26, 2024, the entire contents of which are incorporated herein by reference.

### FIELD

The disclosure herein relates to a method of manufacturing a magnetic recording medium.

### BACKGROUND

In recent years, magnetic storage devices are mounted in various products such as personal computers, video recorders, and data servers, and the importance of the magnetic storage devices has increased. Such a magnetic storage device is a device including a magnetic recording medium that stores electronic data by magnetic recording. Examples of the magnetic storage device include a hard disk drive (HDD).

A general magnetic recording medium has a multilayer film in which, for example, an underlayer, an intermediate layer, a magnetic recording layer, and a protective layer are formed in this order on a non-magnetic substrate and a lubricating layer is formed on the surface of the protective layer.

For example, as described in Japanese Examined Patent Publication No. H2-10486 (Patent Document 1), when a magnetic recording medium is manufactured, a burnishing process using an abrasive tape is performed in order to remove foreign substances and protrusions on the surface of a protective layer.

### SUMMARY

According to one embodiment of the present disclosure, a method of manufacturing a magnetic recording medium includes burnishing, with an abrasive material, a surface of a stack including a magnetic recording layer and a protective layer stacked on a substrate in order of the magnetic recording layer and the protective layer. The burnishing of the surface of the stack includes using a long abrasive tape including abrasive grains as the abrasive material fixed onto a support in a state of being wound in roll form, and pressing the abrasive tape, supplied from the state of being wound in the roll form, against the surface of the stack so as to rub the surface of the stack. The abrasive tape in the state of being wound in the roll form is subjected to vacuum treatment in advance such that loose abrasive grains are reduced.

According to one embodiment of the present disclosure, the productivity of magnetic recording media can be improved.

### BRIEF DESCRIPTION OF THE DRAWINGS

FIG. 1 is a schematic diagram illustrating an example of an abrasive tape wound in roll form;

FIG. 2 is a cross-sectional view illustrating an example of a magnetic recording medium manufactured by a method of manufacturing the magnetic recording medium according to an embodiment of the present disclosure;

FIG. 3 is a diagram illustrating a burnishing process;

FIG. 4 is an enlarged cross-sectional view illustrating an example of an abrasive tape used for burnishing;

FIG. 5 is a schematic diagram illustrating an example of the abrasive tape placed in a vacuum bag;

FIG. 6 is a schematic diagram illustrating an example of a method of removing loose abrasive grains;

FIG. 7 is a schematic diagram illustrating another example of a method of removing loose abrasive grains; and

FIG. 8 is a diagram illustrating an example of a burnishing apparatus used to burnish the surfaces of lubricating layers, formed on the respective surfaces of a stack, with abrasive tapes.

### DESCRIPTION OF THE EMBODIMENTS

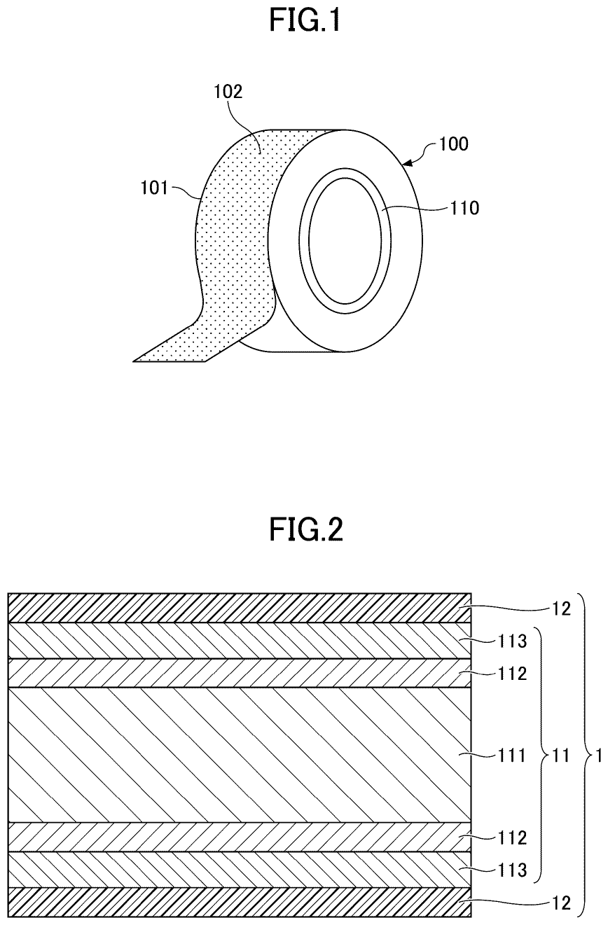

In the burnishing process as described in Patent Document 1, an abrasive tape 100 in which abrasive grains 102, such as alumina, are fixed onto a resin film 101 with a resin is used as illustrated in FIG. 1. The abrasive tape 100 is a long tape having a width of several cm and a length of approximately 100 m, and is supplied in a state of being wound around a core material 110 in roll form.

If foreign substances or loose abrasive grains are mixed into the abrasive tape 100, circumferential scratches would be generated on the surface of a multilayer film in the burnishing process, and dirt would easily adhere to the surface of the multilayer film. For this reason, the abrasive tape 100 is manufactured under quality control such that foreign substances or loose abrasive grains are not mixed into the abrasive tape 100 during the manufacturing process. However, there is a problem in that scratches or dirt, which are considered to be caused by the burnishing process, are still generated in some cases when a magnetic recording medium is manufactured. Magnetic recording media having scratches, dirt, or the like on the surfaces of multilayer films are treated as defective products, thereby decreasing the productivity of the magnetic recording media.

In view of the above, it is an object of one embodiment of the present disclosure to provide a method of manufacturing a magnetic recording medium, by which the productivity of magnetic recording media can be improved.

The present inventors focused on the fact that there is a correlation between the defect rate due to circumferential scratches and dirt on the surface of a magnetic recording medium and a position in a roll of an abrasive tape used in a burnishing process, and found that the defect rate due to the burnishing process is higher on the outer side than the core material side, that is, the inner side of the roll of the abrasive tape. The present inventors investigated the cause and found that loose abrasive grains are generated due to pressure caused by the winding tension of the abrasive tape when the abrasive tape is wound in roll form, and defective products are caused by the loose abrasive grains. Because the pressure caused by the winding tension differs between the inner side and the outer side of the roll of the abrasive tape, the amount of loose abrasive grains differs between the inner side and the outer side of the roll the abrasive tape. Accordingly, the present inventors found that the productivity of magnetic recording media can be improved by subjecting the abrasive tape in a state of being wound in roll form to vacuum treatment before use such that loose abrasive grains can be reduced.

The present disclosure has the following configurations.

[1] A method of manufacturing a magnetic recording medium, the method including:
burnishing a surface of a stack, with an abrasive material, a surface of a stack including a magnetic recording layer and a protective layer stacked on a substrate in order of the magnetic recording layer and the protective layer, wherein
the burnishing of the surface of the stack includes using a long abrasive tape including abrasive grains as the abrasive material fixed onto a support in a state of being wound in roll form, and pressing the abrasive tape, supplied from the state of being wound in the roll form, against the surface of the stack so as to rub the surface of the stack, and
the abrasive tape in the state of being wound in the roll form is subjected to vacuum treatment in advance such that loose abrasive grains are reduced.

[2] The method of manufacturing the magnetic recording medium according to [1], wherein, after the abrasive tape in the state of being wound in the roll form is subjected to the vacuum treatment, the abrasive tape is rewound.

[3] The method of manufacturing the magnetic recording medium according to [1] or [2], wherein the vacuum treatment is performed by holding the abrasive tape in the state of being wound in the roll form at 50 kPa or lower for 1 hour or more.

[4] The method of manufacturing the magnetic recording medium according to any one of [1] to [3], wherein the loose abrasive grains are abrasive grains released from the support of the abrasive tape.

[5] The method of manufacturing the magnetic recording medium according to any one of [1] to [4], wherein the loose abrasive grains are removed by blowing off the loose abrasive grains with a gas.

[6] The method of manufacturing the magnetic recording medium according to any one of [1] to [5], wherein the loose abrasive grains are removed by bringing a given tape into contact with a surface of the abrasive tape and adsorbing the loose abrasive grains onto the given tape.

[7] The method of manufacturing the magnetic recording medium according to any one of [1] to [6], further including:
forming a lubricating layer on the surface of the stack, wherein
the burnishing of the surface of the stack burnishes, with the abrasive material, the surface of the stack on which the lubricating layer is formed.

Embodiments of the present disclosure will be described in detail with reference to the drawings. In order to facilitate understanding of the description, the same components are denoted by the same reference numerals in the drawings, and duplicate descriptions will be omitted as appropriate. In addition, each member illustrated in the drawings may not be to scale. In the present specification, the term “to” indicating a numerical range is meant to include numerical values described before and after the term “to” as the lower limit value and the upper limit value, unless otherwise specified. Further, in the numerical range indicated by the term “to”, when only the upper limit value is affixed with a unit, it is meant that the lower limit value also has the same unit.

Hereinafter, before describing a method of manufacturing a magnetic recording medium according to an embodiment of the present disclosure, a magnetic recording medium manufactured by the method of manufacturing the magnetic recording medium according to the present embodiment will be described.

### [Magnetic Recording Medium]

FIG. 2 is a cross-sectional view illustrating an example of the magnetic recording medium manufactured by the method of manufacturing the magnetic recording medium according to the present embodiment. As illustrated in FIG. 2, a magnetic recording medium 1 includes a stack 11 and a lubricating layer 12 provided on each side of the stack 11.

The stack 11 includes, on each side of a substrate 111, a magnetic recording layer 112 and a protective layer 113 that are stacked in this order from the substrate 111 side.

The substrate 111 is formed of a non-magnetic material. For example, the substrate 111 may be a metal substrate formed of a metal material such as an aluminum alloy, or may be a non-metal substrate formed of a non-metal material such as glass. Further, an NiP alloy layer may be formed on the surface of the metal substrate or the non-metal substrate, for example, by plating, sputtering, or the like.

The magnetic recording layer 112 is a layer provided for recording and reproducing information. For example, the magnetic recording layer 112 is a layer provided for storing data by reversing the direction of magnetization by magnetic energy supplied from a magnetic head of an HDD and maintaining the state of magnetization.

For the magnetic recording layer 112, an FePt-based alloy having an Llo structure, a CoPt-based alloy having an Llo structure, a CoCrPt-based alloy having an hcp structure, or the like can be used.

The magnetic recording layer 112 can be formed by using a publicly-known method such as sputtering or ion beam deposition.

The protective layer 113 is provided for minimizing corrosion of the magnetic recording layer 112. The protective layer 113 is also provided for protecting the surface of the magnetic recording medium 1 from damage when the magnetic head comes into contact with the magnetic recording medium 1. Further, the protective layer 113 is provided for improving the corrosion resistance of the magnetic recording medium 1.

The protective layer 113 can be formed of a well-known material. For example, a hard carbon film or diamond-like carbon (DLC) can be used for the protective layer 113.

The protective layer 113 can be formed by using a publicly-known method such as sputtering or ion beam deposition.

The surface of the protective layer 113 may be hydrogenated or nitrided. When the surface of the protective layer 113 is hydrogenated or nitrided, the bonding strength between the protective layer 113 and the lubricating layer 12 formed on the surface of the protective layer 113 can be increased.

The lubricating layer 12 is provided for minimizing abrasion of the magnetic head and abrasion of the surface of the magnetic recording medium 1 when the magnetic head comes into contact with the magnetic recording medium 1, and improving the corrosion resistance of the magnetic recording medium 1.

The lubricating layer 12 is formed by using a lubricant. As the lubricant, a lubricant generally used when magnetic recording media are manufactured may be used.

The thickness of the lubricating layer 12 is preferably in a range of 5 Å to 10 Å (0.5 nm to 1 nm). By setting the thickness of the lubricating layer 12 to the range of 5 Å to 10 Å (0.5 nm to 1 nm), it is possible to inhibit abrasion of the surface of the magnetic recording medium 1, improve the corrosion resistance of the magnetic recording medium 1, and also achieve a high recording density by reducing the distance between the magnetic head and the magnetic recording medium 1 in the HDD.

### [Method of Manufacturing Magnetic Recording Medium]

The method of manufacturing the magnetic recording medium according to the present embodiment includes forming a stack 11 including a magnetic recording layer 112 and a protective layer 113, which are stacked in this order on each main surface of a substrate 111 (a stack forming process), coating the stack 11 with a lubricant (a coating process), and burnishing a surface of the stack 11, which is coated with the lubricant, with an abrasive material (a burnishing process).

In the method of manufacturing the magnetic recording medium according to the present embodiment, the burnishing process may be performed before the coating process, and the surface of the stack 11 that is not coated with the lubricant may be burnished with the abrasive material.

Further, the method of manufacturing the magnetic recording medium according to the present embodiment may include other processes such as a process of forming an adhesion layer, a soft magnetic underlayer, a seed layer, or an orientation control layer between the substrate 111 and the magnetic recording layer 112.

Further, in a case where the stack 11 includes a plurality of stacked magnetic recording layers 112, the method of manufacturing the magnetic recording medium according to the present embodiment may include a process of forming a non-magnetic recording layer between adjacent magnetic recording layers 112.

In the method of manufacturing the magnetic recording medium according to the present embodiment, first, the stack 11 including the magnetic recording layer 112 and the protective layer 113, which are stacked in this order on each main surface of the prepared substrate 111, is formed (stack forming process).

The stack 11 can be formed by using a general deposition method of forming the magnetic recording layer 112 and the protective layer 113.

First, the magnetic recording layer 112 is formed on each main surface of the substrate 111. As a method of forming the magnetic recording layer 112, a general deposition method such as sputtering (also referred to as a sputtering method) can be used.

In the sputtering, a target including a material for forming the magnetic recording layer 112 can be used.

As the target including the material for forming the magnetic recording layer 112, an FePt-based alloy having an Llo structure, a CoPt-based alloy having an Llo structure, a CoCrPt-based alloy, or the like can be used.

As the sputtering, DC sputtering, DC magnetron sputtering, RF sputtering, or the like can be used.

When the magnetic recording layer 112 is formed, a radio frequency (RF) bias, a DC bias, a pulse DC bias, or the like may be used as required.

As a reactive gas, O₂ gas, H₂O gas, N₂ gas, or the like may be used.

The sputtering gas pressure is appropriately adjusted so as to optimize the characteristics of each layer, and is typically set in a range of approximately 0.1 Pa to approximately 30 Pa.

Next, the protective layer 113 is formed on the magnetic recording layer 112. A method of forming the protective layer 113 is not particularly limited, and examples of the method of forming the protective layer 113 include general deposition methods such as a radio frequency-chemical vapor deposition (RF-CVD) method of forming a film by decomposing a source gas formed of hydrocarbon by high-frequency plasma, an ion beam deposition (IBD) method of forming a film by ionizing a source gas by electrons emitted from a filament, and a filtered cathodic vacuum arc (FCVA) method of forming a film by using a solid carbon target without using a source gas.

In the present embodiment, in the stack forming process, an adhesion layer, a soft magnetic underlayer, a seed layer, an orientation control layer, and the like may be formed between the substrate 111 and the magnetic recording layer 112.

In the present embodiment, in a case where the stack 11 includes a plurality of stacked magnetic recording layers 112, the stack forming process may include a process of forming a non-magnetic recording layer between adjacent magnetic recording layers 112.

Next, a lubricating layer 12, which is a film formed of a lubricant, is formed by coating the surface of the stack 11 with the lubricant (coating process). Accordingly, the magnetic recording medium 1 that is a multilayer body in which the lubricating layer 12 is formed on the surface of the stack 11 is obtained.

The lubricant can be applied by a general coating method such as a dipping method, a spin coating method, or a vapor deposition method.

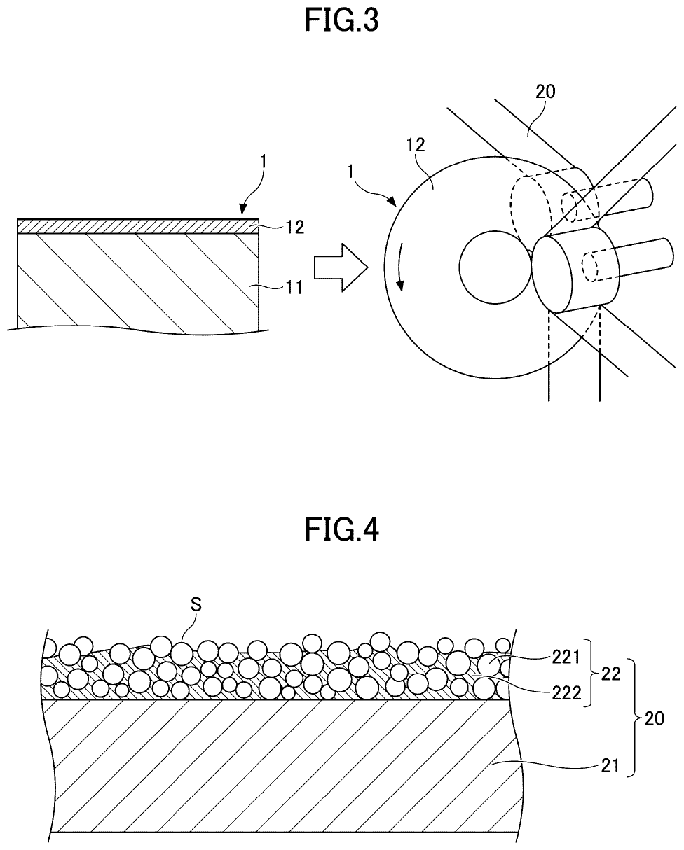

Next, as illustrated in FIG. 3, the surface of the lubricating layer 12 formed on the surface of the stack 11 is burnished with an abrasive tape 20 (burnishing process). Accordingly, the burnished lubricating layer 12 can be stacked on the surface of the stack 11.

In the burnishing process, the abrasive tape 20 in a state of being wound in roll form is used, and the abrasive tape 20 supplied from the state of being wound in roll form is pressed against the surface of the lubricating layer 12 formed on the surface of the stack 11 so as to rub the surface of the lubricating layer 12.

In the present embodiment, as the abrasive tape 20 in the state of being wound in roll form, which is used in the burnishing process, an abrasive tape that is subjected to vacuum treatment in advance so as to reduce loose abrasive grains is used. As described above, when the abrasive tape is wound in roll form, loose abrasive grains may be generated due to pressure caused by the winding tension of the abrasive tape, and such loose abrasive grains would cause defective products. In the present embodiment, loose abrasive grains can be reduced by subjecting the abrasive tape 20 in roll form to vacuum treatment before use. Accordingly, the occurrence of defective products of the magnetic recording medium 1 due to loose abrasive grains can be suppressed, and the productivity of the magnetic recording medium 1 can be improved.

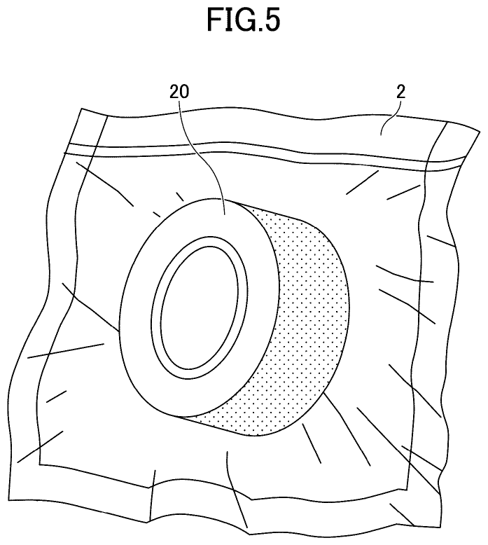

FIG. 4 is an enlarged cross-sectional view illustrating an example of the abrasive tape 20 used for burnishing. As illustrated in FIG. 4, the surface of the lubricating layer 12 is polished by sliding an abrasive surface S of the abrasive tape 20 over the surface of the lubricating layer 12 formed on the surface of the stack 11.

The abrasive tape 20 includes an abrasive material layer 22 on a support 21. The abrasive material layer 22 includes abrasive grains 221 and a binder 222. The binder 222 bonds the abrasive grains 221 to each other and bonds the abrasive grains 221 to the support 21. The binder 222 also fixes the abrasive grains 221 within the abrasive material layer 22.

A material of the support 21 is not particularly limited, and any of various resins such as polyethylene terephthalate may be used as the material of the support 21.

The abrasive grains 221 can be used as an abrasive material included in the abrasive tape 20. Examples of the abrasive grains 221 include particles including chromium oxide, α-alumina, silicon carbide, non-magnetic iron oxide, diamond, γ-alumina, α,γ-alumina, fused alumina, corundum, artificial diamond, and the like. The abrasive grains 221 may be particles of any of the above materials. Any of the above materials may be used alone or two or more of the above materials may be used in combination.

The binder 222 is not particularly limited. As the binder 222, for example, a thermoset resin, a thermoplastic resin, a photosensitive resin, or the like can be used. As the resin used as the binder 222, a single resin may be used alone, or two or more resins may be used in combination.

As described above, the abrasive tape 20 is long. Thus, the abrasive tape 20 is supplied from a state of being wound in roll form as illustrated in FIG. 1, and is set on a reel of a burnishing apparatus in the state of being wound in roll form and used.

As described above, when the abrasive tape 20 is wound in roll form, loose abrasive grains are generated in the roll due to pressure caused by winding tension. If the pressure caused by the winding tension is very high, abrasive grains 221 bonded to the support 21 could be released, but typically, it is considered that abrasive grains 221 weakly bonded to the support 21 or the abrasive grains 221 adhering to bonded abrasive grains 221 are released. It is difficult to completely remove such loose abrasive grains 221 in a manufacturing process of the abrasive tape 20, and it is considered that most of the loose abrasive grains are generated after the abrasive tape 20 is manufactured, that is, after the abrasive tape 20 is wound in roll form.

In the present embodiment, the abrasive tape 20 in roll form is subjected to vacuum treatment before use, and thus, loose abrasive grain 221 can be reduced and the occurrence of defective products due to loose abrasive grains 221 can be suppressed. The following reasons are conceivable as reasons why loose abrasive grains 221 are reduced by the vacuum treatment. That is, the gas within the abrasive tape 20 is removed by the vacuum treatment, and as a result, pressure caused by winding tension is reduced and thus loose abrasive grains 221 due to the winding tension are reduced. Further, the adhesion between layers of the abrasive tape 20 is increased by removing the gas, and thus, loose abrasive grains 221 move from the abrasive material layer 22 to the back surface of the abrasive tape 20. Further, the adhesion between layers of the abrasive tape 20 is increased by removing the gas, and thus, abrasive grains 221 that are likely to be released are pressed against the abrasive material layer 22 by the back surface of the abrasive tape 20, thereby suppressing the release of the abrasive grains 221.

In the present embodiment, the vacuum treatment is preferably performed by holding the abrasive tape 20 in a state of being wound in roll form at as low a pressure as possible, preferably 50 kPa or less, more preferably 10 kPa or less, and most preferably 1 kPa or less, for as long a period of time as possible, preferably 1 hour or more, more preferably 10 hours or more, and most preferably 1 week or more.

The vacuum treatment is preferably performed by holding the abrasive tape 20 in roll form in a vacuum container. However, the vacuum treatment may be performed by holding the abrasive tape 20 in roll form in a vacuum bag 2 as illustrated in FIG. 5. In this case, as the vacuum bag 2, for example, a metal deposition bag or a multilayer resin film bag having high gas barrier properties is preferably used.

In the present embodiment, after the abrasive tape 20 in roll form is subjected to the vacuum treatment, it is preferable to remove loose abrasive grains 221 by rewinding the abrasive tape 20 such that the occurrence of defective products of the magnetic recording medium 1 due to loose abrasive grains 221 can be suppressed. Although the abrasive tape 20 is rewound in roll form again, the reoccurrence of loose abrasive grains 221 can be suppressed even when the abrasive tape 20 is rewound because pressure due to winding tension has already been applied to the abrasive tape 20.

The rewinding speed of the abrasive tape 20 is preferably approximately 1 m/min to 20 m/min. The surface of the abrasive tape 20 receives wind pressure by the rewinding of the abrasive tape 20. Thus, loose abrasive grains 221 on the surface of the abrasive tape 20 can be removed by the wind pressure.

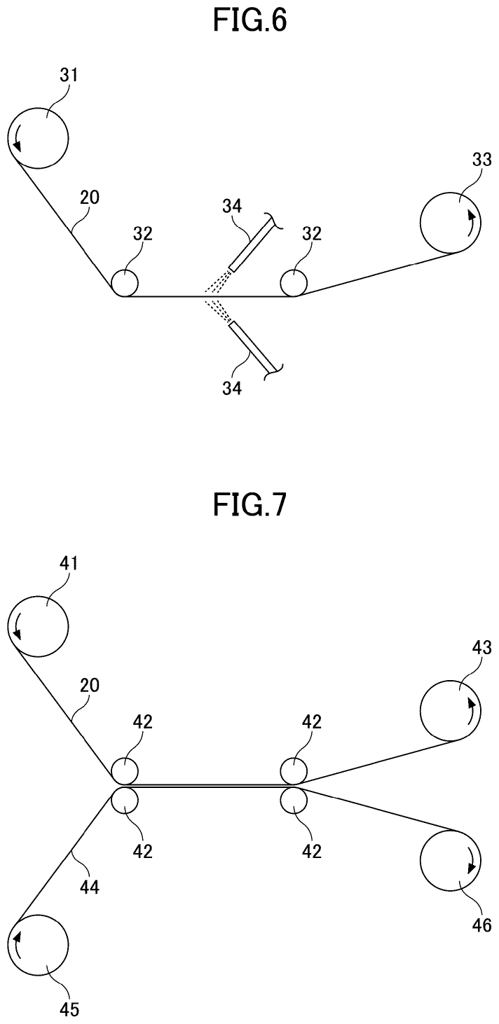

Further, in the present embodiment, as illustrated in FIG. 6, loose abrasive grains 221 within the abrasive tape 20 in roll form are preferably removed by blowing off the loose abrasive grains 221 with a gas. By using such a method, the loose abrasive grains 221 can be removed more efficiently and reliably.

In FIG. 6, the abrasive tape 20 is set on a supply reel 31, and the abrasive tape 20 is wound around a take-up reel 33 while being guided by guide rollers 32. Both surfaces of the abrasive tape 20 are cleaned by a gas injected from a pair of gas injection nozzles 34 during the running of the abrasive tape 20. Loose abrasive grains 221 are preferably removed in an atmosphere from which static charge is eliminated in order to prevent the loose abrasive grains 221 from re-adhering to the abrasive tape 20 due to the static charge.

Further, in the present embodiment, as illustrated in FIG. 7, loose abrasive grains 221 are preferably removed by bringing another tape 44 into contact with the surface of the abrasive tape 20 and adsorbing the loose abrasive grains 221 onto the other tape 44. By using such a method, the loose abrasive grains 221 can be removed more efficiently and reliably.

In FIG. 7, the abrasive tape 20 is set on an abrasive tape supply reel 41, and the abrasive tape 20 is wound around an abrasive tape take-up reel 43 while being guided by guide rollers 42. The surface of the abrasive tape 20 makes contact with the other tape 44 during the running of the abrasive tape 20, and thus loose abrasive grains 221 are removed. The contact surface of the other tape 44 is preferably charged and provided with adhesiveness such that the loose abrasive grains are easily adsorbed onto the contact surface. The other tape 44 is set on another tape supply reel 45, guided by guide rollers 42 to contact the surface of the abrasive tape 20, and then wound around another tape take-up reel 46.

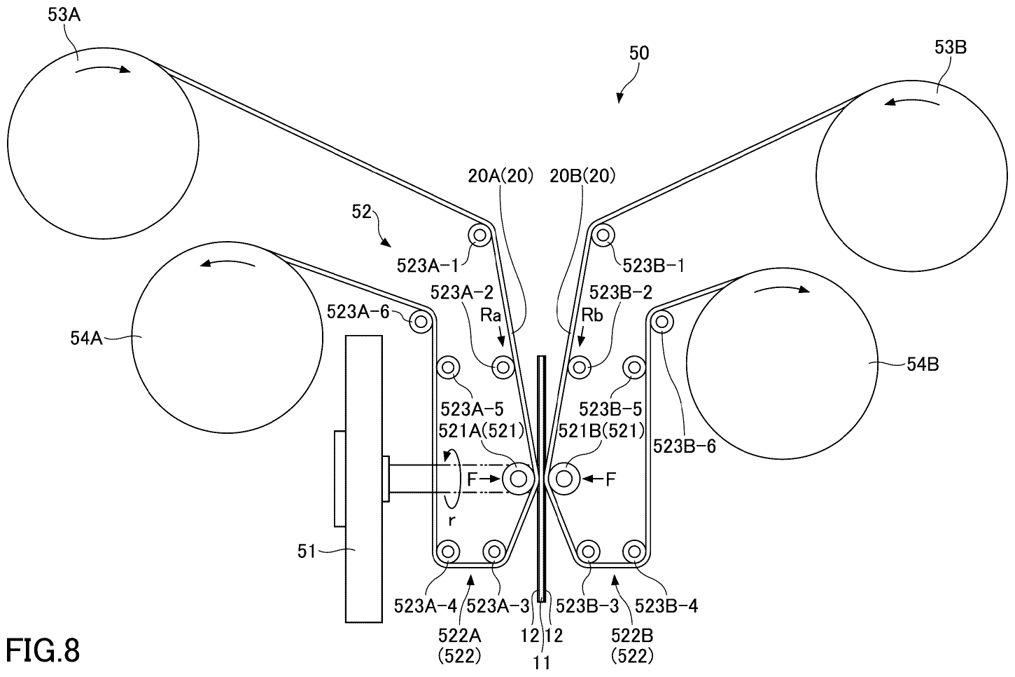

The burnishing process can use a method of pressing a tape (abrasive tape 20) including an abrasive material against the surface of the lubricating layer 12 formed on the surface of the stack 11 so as to rub the surface of the lubricating layer 12. A burnishing method and a burnishing apparatus will be described in detail with reference to FIG. 8.

FIG. 8 is a diagram illustrating an example of a burnishing apparatus used to burnish the surfaces of lubricating layers 12, formed on the respective surfaces of the stack 11, with abrasive tapes 20. As illustrated in FIG. 8, a burnishing apparatus 50 includes a pair of abrasive tapes 20 (hereinafter also referred to as a “pair of abrasive tapes 20A and 20B”), a rotating support 51, and a tape moving mechanism 52. The abrasive tapes 20 in the pair are disposed to face each other such that the stack 11, on both surfaces of which lubricating layers 12 are formed, is interposed between the abrasive tapes 20.

The abrasive tapes 20A and 20B in the pair are respectively supplied from a first abrasive tape supply reel 53A and a second abrasive tape supply reel 53B in a state of being wound in roll form, and are respectively wound around a first abrasive tape take-up reel 54A and a second abrasive tape take-up reel 54B in roll form.

In the burnishing apparatus 50, the abrasive tapes 20A and 20B in the pair are disposed to face each other such that the stack 11, on both surfaces of which the lubricating layers 12 are formed, is interposed between the abrasive tapes 20A and 20B. Thus, the lubricating layers 12 formed on both surface of the stack 11 can be simultaneously burnished with high efficiency.

The rotating support 51 rotates the stack 11, on both surfaces of which the lubricating layers 12 are formed, in a circumferential direction (a direction indicated by an arrow r) with an opening in the center of the stack 11, on both surfaces of which the lubricating layers 12 are formed, being supported by the rotating support 51.

The tape moving mechanism 52 relatively moves the pair of abrasive tapes 20A and 20B in a radius direction of the stack 11, while pressing the pair of abrasive tapes 20A and 20B against the lubricating layers 12 formed on both surfaces of the rotating stack 11 in a direction indicated by an arrow F.

Further, the tape moving mechanism 52 includes a pair of abrasive tape pressing mechanisms 521 and a pair of abrasive tape running systems 522. The pair of abrasive tape pressing mechanisms 521 and the pair of abrasive tape running systems 522 are disposed to face each other so as to sandwich the stack 11, on both surfaces of which the lubricating layers 12 are formed, from both sides with the abrasive tapes 20A and 20B interposed therebetween.

The pair of abrasive tape pressing mechanisms 521 includes a first abrasive tape pressing mechanism 521A and a second abrasive tape pressing mechanism 521B. The pair of abrasive tape running systems 522 includes a first abrasive tape running system 522A and a second abrasive tape running system 522B.

That is, the tape moving mechanism 52 includes the first abrasive tape running system 522A and the first abrasive tape pressing mechanism 521A disposed on one side of the stack 11, on both surfaces of which the lubricating layers 12 are formed, and also includes the second abrasive tape running system 522B and the second abrasive tape pressing mechanism 521B disposed on the other side of the stack 11.

The first abrasive tape running system 522A includes first guide rolls 523A-1 to 523A-6 and causes the abrasive tape 20A to run in a direction indicated by an arrow Ra.

The second abrasive tape running system 522B includes second guide rolls 523B-1 to 523B-6 and causes the abrasive tape 20B to run in a direction indicated by an arrow Rb.

As described above, the method of manufacturing the magnetic recording medium according to the present embodiment includes the burnishing process, and in the burnishing process, the abrasive tapes 20 supplied from a state of being wound in roll form are pressed against the respective surfaces of the stack 11, on which the lubricating layers 12 are formed, so as to rub the surfaces of the stack 11. At this time, the abrasive tapes 20 in the state of being wound in roll form are subjected to vacuum treatment in advance such that loose abrasive grains are removed. Accordingly, the occurrence of circumferential scratches on the surfaces of the lubricating layers 12 formed on both surfaces of the stack 11 due to the loose abrasive grains can be suppressed, and also adhering of the loose abrasive grains to the surfaces of the lubricating layers 12 as dirt such as foreign substances can be suppressed. Therefore, in the method of manufacturing the magnetic recording medium according to the present embodiment, the defect rate of the magnetic recording medium 1 can be reduced in the burnishing process, and thus the productivity of the magnetic recording medium 1 can be increased.

As described above, the magnetic recording medium 1 manufactured by the method of manufacturing the magnetic recording medium according to the present embodiment has few circumferential scratches, dirt, and the like on the surface of the magnetic recording medium 1, and thus the reliability of the quality can be improved. The magnetic recording medium 1 can be suitably used for a magnetic recording and reproducing device because defects in loading and reading of records can be suppressed and a high recording density can be maintained. A configuration of the magnetic recording and reproducing device is not particularly limited, as long as the magnetic recording and reproducing device includes the magnetic recording medium manufactured by the method of manufacturing the magnetic recording medium according to the present embodiment. The magnetic recording and reproducing device may be a magnetic recording and reproducing device in which information is magnetically recorded on the magnetic recording medium using a heat-assisted magnetic recording method.

Although the embodiments have been described above, the above-described embodiments are merely presented as examples, and the present invention is not limited to the above-described embodiments. The above-described embodiments can be implemented in various other forms, and various combinations, omissions, substitutions, changes, and the like can be made without departing from the gist of the present invention. The above-described embodiments and modifications thereof are included in the scope and gist of the present invention, and are included in the invention described in the claims and the scope of equivalents thereof.

### EXAMPLES

The present embodiment will be specifically described through examples, but the present embodiment is not limited to these examples.

### Example 1

### [Preparation of Abrasive Tape]

For an abrasive tape, Al₂O₃ (manufactured by Mipox Corporation) having a particle size of 0.2 μm was used as abrasive grains that serve as an abrasive material. The abrasive tape had a width of 12.6 mm and a length of 100 m and was wound in roll form. The abrasive tape was subjected to vacuum treatment at 10 kPa for 10 hours. Thereafter, the abrasive tape was rewound as additional treatment by using the apparatus illustrated in FIG. 6, thereby removing loose abrasive grains. At this time, the abrasive tape was caused to run at 10 m/min without injecting gas from the gas injection nozzle 34. The rewinding was performed in a static-free environment.

The conditions of the vacuum treatment and the content of the additional treatment when the abrasive tape was prepared are indicated in Table 1.

### [Production of Magnetic Recording Medium]

A cleaned glass substrate (having an outer shape of 2.5 inches and manufactured by HOYA Corporation) was placed in a deposition chamber of a DC magnetron sputtering apparatus (C-3040 manufactured by Anelva Corporation), and the deposition chamber was evacuated to an ultimate vacuum of 1×10⁻⁵ Pa. Then, an adhesion layer having a thickness of 10 nm was formed on the glass substrate using a Cr target by sputtering.

Next, a soft magnetic underlayer was formed on the adhesion layer by sputtering. As the soft magnetic underlayer, a first soft magnetic recording layer, an intermediate layer, and a second soft magnetic recording layer were sequentially formed. First, the first soft magnetic recording layer having a thickness of 25 nm was formed at a substrate temperature of 100° C. or lower, using a Co-20Fe-5Zr-5Ta target {an Fe content of 20 at. %, a Zr content of 5 at. %, a Ta content of 5 at. %, and the remainder of Co}. Next, the intermediate layer formed of Ru and having a thickness of 0.7 nm was formed. Thereafter, the second soft magnetic recording layer formed of Co-20Fe-5Zr-5Ta and having a thickness of 25 nm was formed.

Next, a seed layer having a thickness of 5 nm was formed on the soft magnetic underlayer by sputtering using an Ni-6W target {a W content of 6 at. % and the remainder of Ni}.

Thereafter, as a first orientation control layer, a Ru layer having a thickness of 10 nm was formed on the seed layer by sputtering at a sputtering pressure of 0.8 Pa. Next, as a second orientation control layer, a Ru layer having a thickness of 10 nm was formed on the first orientation control layer by sputtering at a sputtering pressure of 1.5 Pa.

Subsequently, a first magnetic recording layer formed of 91 (Co15Cr16Pt)-6(SiO₂)-3(TiO₂) {91 mol % of an alloy having a Cr content of 15 at. %, a Pt content of 16 at. %, and the remainder of Co, 6 mol % of SiO₂, and 3 mol % of TiO₂} was formed on the second orientation control layer by sputtering so as to have a thickness of 9 nm. The sputtering pressure was 2 Pa.

Next, a non-magnetic recording layer formed of 88(Co30Cr)-12(TiO₂) {88 mol % of an alloy having a Cr content of 30 at. % and the remainder of Co, and 12 mol % of TiO₂} was formed on the first magnetic recording layer by sputtering so as to have a thickness of 0.3 nm.

Thereafter, a second magnetic recording layer formed of 92(Co11Cr18Pt)-5(SiO₂)-3(TiO₂) {92 mol % of an alloy having a Cr content of 11 at. %, a Pt content of 18 at. %, and the remainder of Co, 5 mol % of SiO₂, and 3 mol % of TiO₂} was formed on the non-magnetic recording layer by sputtering so as to have a thickness of 6 nm. The sputtering pressure was 2 Pa.

Thereafter, a non-magnetic recording layer formed of Ru was formed on the second magnetic recording layer by sputtering so as to have a thickness of 0.3 nm.

Subsequently, a third magnetic recording layer was formed on the non-magnetic recording layer by sputtering at a sputtering pressure of 0.6 Pa, using a Co-20Cr-14Pt-3B target {Cr content of 20 at. %, a Pt content of 14 at. %, a B content of 3 at. %, and the remainder of Co}, so as to have a thickness of 7 nm.

A hydrogenated carbon film was formed as a protective layer on the surface of the third magnetic recording layer by ion beam deposition using gasified toluene as a source gas. When the hydrogenated carbon film was formed, the flow rate of the source gas supplied into the deposition chamber was set to 2.9 SCCM and the reaction pressure was set to 0.2 Pa. Further, a cathode power serving as an excitation source of the source gas was set to 225 W (AC 22.5 V, 10 A). Then, the voltage and current between a cathode electrode and an anode electrode covering the cathode electrode were set to 75 V and 1, 650 mA, respectively, the ion acceleration voltage was set to 200 V, the current was set to 180 mA, and the deposition time was set to 1.5 seconds such that the hydrogenated carbon film having a thickness of 3.5 nm was formed. After the hydrogenated carbon film was formed, the supply of the source gas was stopped and the deposition chamber was evacuated for 2 seconds.

Subsequently, nitrogen gas was supplied into the deposition chamber at a flow rate of 2 SCCM and a reaction pressure of 5 Pa. The cathode power was set to 128 W (AC 16 V, 8 A), the voltage and current between the cathode electrode and the anode electrode were set to 75 V and 1,000 mA, respectively, the ion acceleration voltage was set to 200 V, the current was set to 90 mA, and the processing time was set to 1 second. Then, the surface of the hydrogenated carbon film was irradiated with nitrogen ions generated from the nitrogen gas so as to be exposed to a nitrogen plasma. In this manner, the surface of the hydrogenated carbon film was dehydrogenated and nitrided.

Next, the surface of the protective layer was coated with a lubricant (D5OH(XS) manufactured by MORESCO Corporation) by dipping such that a lubricating layer formed of the lubricant and having a thickness of approximately 7 Å (0.7 nm) was formed.

Next, the surface of a stack on which the lubricating layer was formed was burnished with the abrasive tape subjected to the above-described vacuum treatment. As burnishing conditions, the rotational speed of the stack was set to 2,000 rpm, and the processing time was set to 7 seconds. By performing the burnishing, a magnetic recording medium in which the burnished lubricating layer is stacked on the surface of the stack was obtained.

### [Measurement of Thermal Asperity (TA) Count]

An optical inspection was performed on magnetic recording media produced as described above, and magnetic recording media having large scratches or particles adhering thereto were excluded. Next, a burnish head was used to remove foreign substances adhering to magnetic recording media, and subsequently a glide head was used to perform a glide test. The glide test is a test method in which vibrations generated when the glide head collides with protrusions on the surface of a magnetic recording medium are detected by an AE sensor attached to the glide head. TA count evaluation was performed for magnetic recording media that passed the glide test. An MR head was used for the TA count evaluation. The TA count evaluation is a method of detecting a phenomenon in which a signal waveform reproduced by the MR head varies due to frictional heat generated when the MR head collides with protrusions on the surface of a magnetic recording medium, that is, a thermal asperity (TA), and evaluating the surface smoothness of the magnetic recording medium from the number of occurrences of signals (the TA count). The smaller the TA count is, the higher the surface smoothness of the magnetic recording medium is. The TA counts were obtained by using the abrasive tape having the length of 100 m. Specifically, the TA counts were obtained by calculating an average value of the TA counts per surface of one hundred magnetic recording media, which were burnished with a portion of the abrasive tape located at a position about 20 m from one end of the abrasive tape where the abrasive tape is wound outwardly, and an average value of the TA counts per surface of one hundred magnetic recording media, which were burnished with a portion of the abrasive tape located at a position about 80 meters from the end of the abrasive tape where the abrasive tape is wound outwardly. A region from the end to about 20 meters of the abrasive tape is located on the outer side of the abrasive tape, and a region from 20 meters to 100 meters in the longitudinal direction of the abrasive tape is located on the inner side of the abrasive tape. Evaluation results are indicated in Table 1.

### Examples 2 and 3 and Comparative Examples 1 and 2

Magnetic recording media were produced in the same manner as in Example 1 except that preparation conditions of abrasive tapes were changed as follows, and the TA counts of the magnetic recording media were measured. Evaluation results are indicated in Table 1.

### Example 2

An abrasive tape was prepared in the same manner as in Example 1 except that nitrogen gas was injected from the gas injection nozzles 34 of the apparatus illustrated in FIG. 6.

### Example 3

Loose abrasive grains were removed by rewinding an abrasive tape by using the apparatus illustrated in FIG. 7. A charged polyethylene tape was used as another tape to be brought into contact with the abrasive tape, and the running speed of the tape was set to 10 m/min. The static charge of the abrasive tape was eliminated and the abrasive tape was rewound. The abrasive tape was prepared in the same manner as in Example 1 except for the above points.

### Comparative Examples 1 and 2

Abrasive tapes were prepared in the same manner as in Example 1 except that vacuum treatment and rewinding were changed as indicated in Table 1.

TABLE 1

| | | | TA COUNT (NUMBER) | |
|---|---|---|---|---|
| | | | ABOUT 20 m | ABOUT 80 m |
| | | | FROM ONE END | FROM ONE END |
| | PREPARATION OF ABRASIVE TAPE | | WHERE ABRASIVE | WHERE ABRASIVE |
| | VACUUM | ADDITIONAL | TAPE IS WOUND | TAPE IS WOUND |
| | TREATMENT | TREATMENT | OUTWARD | OUTWARD |
| EXAMPLE 1 | 10 kPa, | REWINDING | 7 | 7 |
| | 10 HOURS | | | |
| EXAMPLE 2 | 10 kPa, | REWINDING WHILE | 6 | 6 |
| | 10 HOURS | INJECTING | | |
| | | NITROGEN GAS | | |
| EXAMPLE 3 | 10 kPa, | REWINDING WHILE | 6 | 6 |
| | 10 HOURS | BRINING CHARGED | | |
| | | TAPE INTO CONTACT | | |
| COMPARATIVE | NONE | NONE | 50 | 10 |
| EXAMPLE 1 | | | | |
| COMPARATIVE | NONE | REWINDING | 9 | 9 |
| EXAMPLE 2 | | | | |

As indicated in Table 1, in Comparative Example 1, the TA count was different between the inner side and the outer side of the roll of the abrasive tape with which burnishing was performed. This is considered to be because the amount of generated loose abrasive grains was different between the inner side and the outer side of the roll of the abrasive tape due to pressure caused by winding tension within the roll of the abrasive tape. Conversely, in Examples 1 to 3, the TA count was the same between the inner side and the outer side of the roll of the abrasive tape, and was as low as 7 or less. This is considered to be because the abrasive tape was subjected to vacuum treatment in advance, and thus loose abrasive grains located on the inner side and the outer side of the roll were removed.

Therefore, it can be said that subjecting an abrasive tape to vacuum treatment when the abrasive tape is prepared allows the defect rate in a burnishing process when magnetic recording media are manufactured to be reduced and the productivity of the magnetic recording media to be improved.

What is claimed is:

1. A method of manufacturing a magnetic recording medium, the method comprising:
burnishing, with an abrasive material, a surface of a stack including a magnetic recording layer and a protective layer stacked on a substrate in order of the magnetic recording layer and the protective layer, wherein
the burnishing of the surface of the stack includes using a long abrasive tape including abrasive grains as the abrasive material fixed onto a support in a state of being wound in roll form, and pressing the abrasive tape, supplied from the state of being wound in the roll form, against the surface of the stack so as to rub the surface of the stack, and
the abrasive tape in the state of being wound in the roll form is subjected to vacuum treatment in advance such that loose abrasive grains are reduced.

2. The method of manufacturing the magnetic recording medium according to claim 1, wherein, after the abrasive tape in the state of being wound in the roll form is subjected to the vacuum treatment, the abrasive tape is rewound.

3. The method of manufacturing the magnetic recording medium according to claim 1, wherein the vacuum treatment is performed by holding the abrasive tape in the state of being wound in the roll form at 50 kPa or lower for 1 hour or more.

4. The method of manufacturing the magnetic recording medium according to claim 1, wherein the loose abrasive grains are abrasive grains released from the support of the abrasive tape.

5. The method of manufacturing the magnetic recording medium according to claim 1, wherein the loose abrasive grains are removed by blowing off the loose abrasive grains with a gas.

6. The method of manufacturing the magnetic recording medium according to claim 1, wherein the loose abrasive grains are removed by bringing a given tape into contact with a surface of the abrasive tape and adsorbing the loose abrasive grains onto the given tape.

7. The method of manufacturing the magnetic recording medium according to claim 1, further comprising:
forming a lubricating layer on the surface of the stack, wherein
the burnishing of the surface of the stack burnishes, with the abrasive material, the surface of the stack on which the lubricating layer is formed.
